(19) United States
(12) Patent Application Publication
(10) Pub. No.: US 2002/0161118 A1
(43) Pub. Date: Oct. 31, 2002

(54) Rubber mixtures with polyurea fillers

(76) Inventors: Thomas Scholl, Bergisch Gladbach (DE); Roland Parg, Leverkusen (DE)

Correspondence Address: BAYER CORPORATION, PATENT DEPARTMENT, 100 BAYER ROAD, PITTSBURGH, PA, 15205, US

(21) Appl. No.: 09/894,554

(22) Filed: Jun. 28, 2001

(30) Foreign Application Priority Data
Jul. 4, 2000 (DE) 10032353.7

(51) Int. Cl. C08F 8/30

(52) U.S. Cl. 525/123

(57) ABSTRACT

Rubber mixtures according to the invention consist of rubber and specific polyurea fillers with a particle size of 0.001 to 500 μm and are particularly suitable for producing rubber vulcanizates and rubber molded items with low specific weights and low dynamic damping, in particular for producing low-damping tires and industrial rubber articles with a demanding range of physical requirements.

### FIELD OF THE INVENTION

The present invention provides rubber mixtures of rubber and specific polyurea fillers, a process for preparing the rubber mixtures according to the present invertion and use of the rubber mixtures to prepare rubber vulcanizates and molded items of all types, in particular industrial rubber articles and tires with low specific weights and low dynamic damping, as well as the vulcanizates and molded items themselves.

### BRIEF DESCRIPTION OF THE DRAWING

FIG. 1 shows transmission electron microscope image of the HNBR vulcanizate in accordance with Example 6.1.

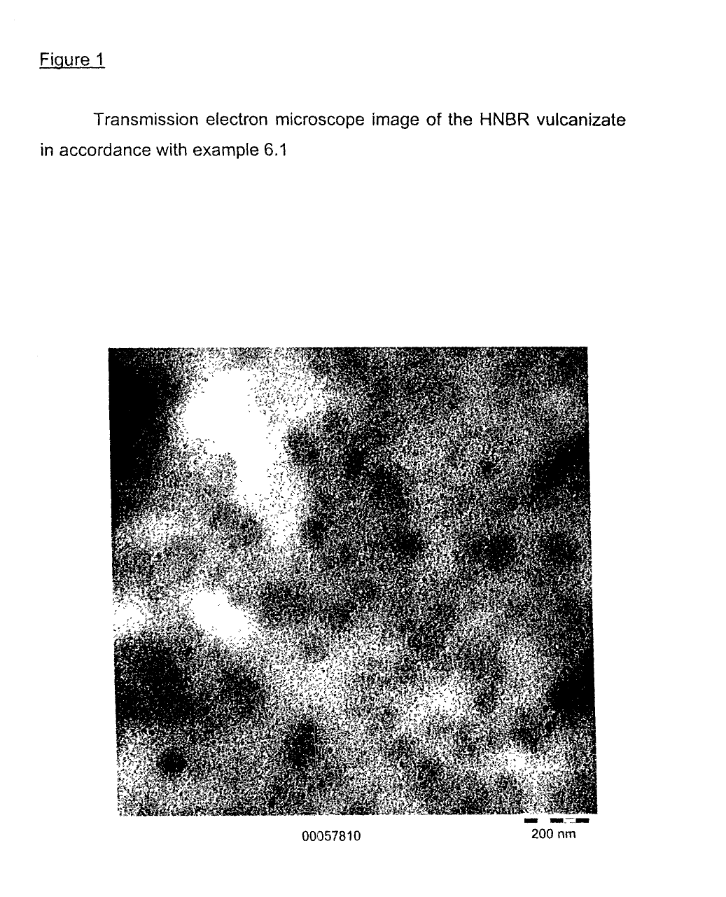

### BACKGROUND OF THE INVENTION

To lower the dynamic damping and to reduce the weight of rubber articles, a number of measures have been described in the prior art, including the use of organic fillers instead of carbon black, such as e.g. rubber gels (EP-A 405 216 and DE-A 4 220 563), starch (EP-A 795 581) or cellulose fibers (EP-A 905 186).

U.S. Pat. No. 5,223,599 describes tires made from polyurea/polyurethanes. However, the polyurea/polyurethanes are not used as fillers here, but as elastomers and therefore, naturally, have quite different physical properties and a very much lower resistance to hydrolysis than the rubbers and vulcanizates in the present invention, which possess no hydrolyzable rubber chains.

The preparation and use of polyureas is also described in the Encyclopedia of Polymer Science and Engineering, John Wiley, New York 1988, vol. 13, pages 212-243. However, no indication is given about the use of specific polyureas as fillers in rubbers.

### SUMMARY OF THE INVENTION

It has now been found that rubber mixtures and vulcanizates with especially good mechanical and dynamic properties can be prepared from rubbers and specific polyureas with a certain particle size, and these are exceptionally suitable for preparing highly reinforced molded items, in particular, tires and industrial rubber articles.

### DETAILED DESCRIPTION OF THE INVENTION

Therefore, the present invention provides rubber mixtures containing a rubber and of 1 to 300, preferably 5 to 150 parts by wt., with respect to 100 parts by wt. of rubber, of a polyurea filler with a particle size of 0.001 to 500 μm, preferably 0.001 to 100 μm, most preferably 0.01 to 20 μm and optionally, other rubber auxiliary substances and cross-linking agents.

The invention also provides a process for preparing polyurea-filled rubber mixtures which is characterized in that at least one polyisocyanate reacts with at least one polyamine and/or water at temperatures of −100° C. to 250° C., preferably 20° C. to 150° C., in a solvent with precipitation of the polyurea, a solution of a rubber is mixed with the polyurea obtained and the solvent is removed.

The solvent used during preparation of the rubber mixtures according to the present invention is preferably removed by steam distillation.

In a most preferred embodiment, the polyurea is prepared by reacting a polyisocyanate with a polyamine in a rubber solution or in an emulsion of a rubber solution and water so that rubber mixtures according to the present invention can be prepared without using an additional solvent.

The polyureas are prepared by reacting polyisocyanates with polyamines and/or water and have the particle sizes mentioned above and melting or decomposition points of ≧150° C., preferably ≧180° C., most preferably ≧200° C. Their glass transition temperatures, if they exist, are higher than 50° C., preferably higher than 100° C.

Suitable polyisocyanates for preparing the polyureas are e.g. hexamethylene diisocyanate (HDI), toluene diisocyanate (TDI), 2,2′-,2,4′ and 4,4′-diisocyanatodiphenylmethane (MDI), polymethylene-polyphenyl isocyanate (PMDI), naphthalene diisocyanate (NDI), 1,6-diisocyanato-2,2,4-trimethylhexane, isophorone diisocyanate (3-(isocyanatomethyl)-3,5,5-trimethylcyclohexyl isocyanate, IPDI), tris-(4-isocyanato-phenyl)-methane, tris-(4-isocyanato-phenyl) phosphate, tris-(4-isocyanato-phenyl) thiophosphate and also oligomerization products, which have been obtained by reaction of the low molecular weight diisocyanates mentioned with diols or polyalcohols, in particular ethylene glycol, 1,4-butanediol, 1,6-hexanediol, trimethylolpropane or pentaerythritol and have a residual concentration of free isocyanate groups. Furthermore, oligomerization products which have been obtained by reacting the low molecular weight diisocyanates mentioned with hydroxy group-containing polyesters such as e.g. polyesters based on adipic acid and butanediol and hexanediol with molecular weights of 400 to 3,000 or by reacting with hydroxy group-containing polyethers such as polyethylene glycols, polypropylene glycols, polytetrahydrofurans with molecular weights between 150 and 3,000 and have a residual concentration of free isocyanate groups, also oligomerization products which have been obtained by reacting the low molecular weight diisocyanates mentioned with water or by dimerization or trimerization such as e.g. dimerized toluene diisocyanate (Desmodur TT) and trimerized toluene diisocyanate, isocyanate group-containing aliphatic polyuretdiones, e.g. those based on isophorone diisocyanate and have a residual concentration of free isocyanate groups. Preferred concentrations of free isocyanate groups are 2.5 to 50 wt. %, preferably 10 to 50 wt. %, particularly preferably 15 to 50 wt. %. These types of polyisocyanates are known and are commercially available. See, on this topic, Houben-Weyl, Methoden der organischen Chemie, vol. XIV, pages 56-98, Georg Thieme Verlag, Stuttgart 1963, Encyclopedia of Chem. Technol., John Wiley 1984, vol. 13, pages 789-818, Ullmann's Encyclopedia of Industrial Chemistry, VCH, Weinheim, 1989, vol. A14, pages 611-625 and the commercial products in the Desmodur and Crelan ranges (Bayer AG).

Suitable polyisocyanates are also blocked polyisocyanates which can react with polyamines under the reaction conditions mentioned. Included here are all the polyisocyanates already mentioned, wherein the isocyanate groups are each blocked with suitable elimination groups which are eliminated at elevated temperature and release the isocyanate groups again. Suitable elimination groups are, in particular, caprolactam, malonates, phenol and alkylphenols such as e.g. nonylphenol, and also imidazole and sodium hydrogen sulfite. More preferred are caprolactam, malonate and alkylphenol-blocked polyisocyanates, in particular those based on toluene diisocyanate or trimerized toluene diisocyanate. Preferred concentrations of blocked isocyanate groups are 2.5 to 30%. These types of blocked polyisocyanates are known and are commercially available. See, on this topic, Houben-Weyl, Methoden der organischen Chemie, vol. XIV, pages 56-98, Georg Thieme Verlag, Stuttgart 1963 and the commercial products in the Desmodur and Crelan ranges (Bayer AG).

Preferred polyisocyanates are hexamethylene diisocyanate (HDI), toluene diisocyanate (TDI), 2,4′- and 4,4′-diisocyanatodiphenylmethane (MDI), polymethylene-polyphenyl isocyanate (PMDI), 1,6-diisocyanato-2,2,4-trimethylhexane, isophorone diisocyanate (IPDI), and oligomerization products which have been obtained by reacting the low molecular weight diisocyanates mentioned with water or with diols or polyalcohols, in particular ethylene glycol, 1,4-butanediol, 1,6-hexanediol, trimethylol-propane and pentaerythritol, and have a residual concentration of free isocyanate groups, and also oligomerization products which have been obtained by dimerization or trimerization such as dimerized toluene diisocyanate (Desmodur TT) and trimerized toluene diisocyanate, isocyanate group-containing aliphatic polyuretdiones, e.g. based on isophorone diisocyanate, and have a concentration of free isocyanate groups of 2.5 to 50 wt. %, preferably 10 to 50 wt. % and particularly preferably 15 to 50 wt. %.

Most preferred are 2,4′- and 4,4′-diisocyanato-diphenylmethane (MDI) and polymethylene-polyphenyl isocyanate (PMDI).

Suitable polyamines are aliphatic diamines and polyamines such as hydrazine, ethylene diamine, 1,2-propylene diamine, 1,3-propylene diamine, 1-amino-3-methylamino-propane, 1,4-diaminobutane, N,N′-dimethylethylene diamine, 1,6-diaminohexane, 1,12-diaminododecane, 2,5-diamino-2,5-dimethylhexane, trimethyl-1,6-hexane diamine, diethylene triamine, N,N′,N″-trimethyldiethylene triamine, triethylene tetramine, tetraethylene pentamine, pentaethylene hexamine, polyethylene imine with molecular weights between 250 and 10,000, dipropylene triamine, tripropylene tetramine, bis-(3-aminopropyl)-amine, bis-(3-aminopropyl)-methylamine, piperazine, 1,4-diamino-cyclohexane, isophorone diamine, N-cyclohexyl-1,3-propane diamine, bis-(4-amino-cyclohexyl)-methane, bis-(4-amino-3-methyl-cyclohexyl)-methane, bis-aminomethyl-tricyclodecane (TCD diamine), o-, m- and p-phenylene diamine, 1,2-diamino-3-methylbenzene, 1,3-diamino-4-methylbenzene (2,4-diaminotoluene), 1,3-bis-aminomethyl-4,6-dimethylbenzene, 2,4- and 2,6-diamino-3,5-diethyltoluene, 1,4- and 1,6-diaminonaphthalene, 1,8- and 2,7-diamino-naphthalene, bis-(4-aminophenyl)-methane, polymethylene-polyphenylamine, 2,2-bis-(4-aminophenyl)-propane, 4,4′-oxybisaniline, 1,4-butanediol-bis-(3-aminopropyl ether), hydroxyl group-containing polyamines such as 2-(2-aminoethylamino)-ethanol, carboxyl group-containing polyamines such as 2,6-diamino-hexanoic acid. Also amine group-containing liquid polybutadienes or acrylonitrile/butadiene copolymers with average molecular weights of preferably between 500 and 10,000 and amine group-containing polyethers, e.g. those based on polyethylene oxide, polypropylene oxide or polytetrahydrofuran with a concentration of primary or secondary amine groups of 0.25 to about 8 mmol/g, preferably 1 to 8 mmol/g. These types of amine group-containing polyethers are commercially available (e.g. Jeffamin D-400, D-2000, DU-700, ED-600, T-403 and T-3000 from the Texaco Chem. Co.).

More preferred polyamines are hydrazine, ethylene diamine, 1,2-propylene diamine, 1,3-propylene diamine, 1-amino-3-methylaminopropane, 1,4-diaminobutane, N,N′-dimethyl-ethylene diamine, 1,6-diaminohexane, diethylene triamine, N,N′,N″-trimethyldiethylene triamine, triethylene tetramine, tetraethylene pentamine, pentaethylene hexamine, polyethylene imine with molecular weights between 250 and 10,000, dipropylene triamine, tripropylene tetramine, isophorone diamine, 2,4-diaminotoluene and 2,6-diaminotoluene, bis-(4-aminophenyl)-methane, polymethylene-polyphenylamine and amine group-containing liquid polybutadienes or acrylonitrile/butadiene copolymers with average molecular weights of preferably between 500 and 10,000 and amine group-containing polyethers, e.g. those based on polyethylene oxide, polypropylene oxide, with a concentration of primary or secondary amine-groups of 1 to 8 mmol/g.

Most preferred polyamines are ethylene diamine, 1,2-propylene diamine, 1,3-propylene diamine, diethylene triamine, triethylene tetramine, tetraethylene pentamine, pentaethylene hexamine, polyethylene imine with a molecular weight between 250 and 10,000, 2,4-diaminotoluene and 2,6-diaminotoluene, bis-(4-amino-phenyl)-methane and polymethylene-polyphenylamine and also amine group-containing polyethers, e.g. those based on polyethylene oxide, polypropylene oxide, with a concentration of primary or secondary amine groups of 1 to 8 mmol/g and molecular weights between 250 and 2000.

In addition to polyamines, other compounds which can react with polyisocyanates may also be added, in particular, monoamines such as ammonia, C₁ to C₁₈ alkyl amines and di-(C₁ to C₁₈ alkyl) amines and also aryl amines such as aniline, C₁-C₁₂ alkylaryl amines and aliphatic, cycloaliphatic or aromatic mono, di or poly C₁ to C₁₈ alcohols, aliphatic, cycloaliphatic or aromatic mono, di or C₁ to C₁₈ carboxylic acids, aminosilanes such as 3-aminopropyltrimethoxysilane and 3-aminopropyl-triethoxysilane, and also carboxyl, epoxy or hydroxyl group-containing liquid polybutadienes or acrylonitrile/butadiene copolymers with average molecular weights of, preferably, between 500 and 10,000 and polyethers and polyesters with molecular weights between 200 and 10,000, which have hydroxyl and/or carboxyl groups able to react with polyisocyanates are used. Examples of these additionally used monoamines are ammonia, methylamine, dimethylamine, dodecylamine, octadecylamine, oleylamine, ethanolamine, diethanolamine, beta-alanine or aminocaproic acid. The amount of these additional amines, alcohols, carboxylic acids, hydroxyl and/or carboxyl group-containing polyethers and polyesters depends on their concentration of groups able to react with polyisocyanates and is 0 to 0.5 mol of reactive groups per isocyanate equivalent.

Polyurea fillers according to the present invention may, as mentioned, be prepared by reacting at least one polyisocyanate with at least one polyamine and/or water at temperatures of −100 to 250° C., preferably 20 to 150° C., in a solvent with precipitation of the polyurea. Preferred solvents, apart from water, are aprotic solvents, in particular hydrocarbons such as butane, pentane, n-hexane, cyclohexane, n-octane, isooctane, benzene, toluene, xylene and/or chlorobenzene.

In the dry state, the polyurea fillers are present in an aggregated form. The aggregates can be broken up by mechanical processing, e.g. by milling. The particle size can be determined, for example, by electron microscopy, light scattering or ultracentrifuging.

A particularly beneficial process for preparing polyurea-filled rubbers is characterized in that at least one polyisocyanate is reacted with at least one polyamine and/or water in a solvent with precipitation of the polyurea, a solution of a rubber is added thereto and the solvent is removed. The polyurea filler is preferably prepared directly in the rubber solution. This process has the advantage that the polyurea filler is produced immediately with the required particle size.

The concentration of rubber in the solution may vary over wide limits and is generally 1 to 50 wt. %, preferably 5 to 30 wt. %. For economic reasons, the highest possible concentration of rubber in the solution is preferred.

The polyisocyanate is preferably reacted with the polyamine in such a way that the polyisocyanate is initially introduced in the solvent or in an emulsion of solvent and water and the polyamine is then admixed, or the polyamine is initially introduced in the solvent or in an emulsion of solvent and water and the polyisocyanate is then admixed, and the rubber solution is added thereto. In a most preferred embodiment, the reaction is performed in the rubber solution or in an emulsion of the rubber solution and water. The amounts of polyisocyanate, polyamine and optionally water are governed by the degree of filling required in the resulting rubber mixture and by the desired properties of the polyurea filler which may still contain, for example, bonded amine groups when an excess of polyamine is used or bonded isocyanate groups when an excess of polyisocyanate is used.

Preferred relative amounts of polyisocyanate and polyamine are 0.7 to 1.3, preferably 0.8 to 1.2 mol of isocyanate groups per mol of amine groups. Water may, optionally, be used in large excess either as solvent or emulsifier or also for reaction because it can react with isocyanate groups to form amine groups, which then react further with the remaining isocyanate groups.

To regulate the polyurea particle size, emulsifiers and dispersants may be added before or during the preparation process. Suitable emulsifiers and dispersants are those with an anionic, cationic or non-ionic character such as the Na salt of dodecylbenzenesulfonic acid, dioctyl sulfosuccinate, the Na salt of naphthalenesulfonic acid, triethylbenzylammonium chloride or polyethylene oxide ethers such as the reaction products of nonylphenol with 3 to 50 mol of ethylene oxide per mol of nonylphenol. The amounts of emulsifiers or dispersants are about 0.1 to 5 wt. %, with respect to the total amount of polyurea.

The reaction times for the process according to the present invention are between a few seconds and several hours.

The rubber solution, before during or after production of the polyurea filler, apart from the rubber, may also contain fillers, in particular carbon black and/or silica, and also rubber auxiliary substances such as mineral oils, pigments and stabilizers. Preferred amounts of carbon black are 0.1 to 100 parts by wt., of mineral oils are 0.1 to 50 parts by wt. and of stabilizers are 0.1 to 3 parts by wt., each with respect to 100 parts by wt. of rubber.

Both natural rubbers and synthetic rubbers are suitable for preparing rubber mixtures with polyurea fillers according to the present invention.

Preferred synthetic rubbers are, for example, those described in W. Hofmann, Kautschuktechnologie, Gentner Verlag, Stuttgart 1980 and 1. Franta, Elastomers and Rubber Compounding Materials, Elsevier, Amsterdam 1989. They include, inter alia,

| | |
|---|---|
| ACM | polyacrylate rubber and ethylene/C₁-C₄ alkyl acrylate |
| | copolymers |
| BR | polybutadiene |
| ABR | butadiene/C₁-C₄ alkyl acrylate copolymers |
| CR | polychloroprene |
| IR | polyisoprene |
| SBR | styrene/butadiene copolymers with styrene contents of 1-60, |
| | preferably 20-50 wt. %, and optionally 0 to 10 wt. % of polar |
| | unsaturated monomers such as (meth)acrylic acid, |
| | hydroxyethyl (meth)acrylate, acrylonitrile or vinylpyridine |
| IIR | isobutylene/isoprene copolymers with isoprene contents of |
| | 0.01 to 5 wt. % (butyl rubbers) |
| BR-IIR | brominated isobutylene copolymers with bromine contents |
| | between 0.01 and 4 wt. % (bromobutyl rubber) |
| CI-IIR | chlorinated isobutylene copolymers with chlorine contents |
| | between 0.01 and 4 wt. % (chlorobutyl rubber) |
| IMS | isobutylene/p-methylstyrene copolymers |
| BIMS | brominated copolymers with 0.05 to 3 mol. % of benzylically |
| | bonded bromine |
| NBR | butadiene/acrylonitrile copolymers with acrylonitrile contents |
| | of 5-60, preferably 10-40 wt. % and optionally 0 to 10 wt. % of |
| | other polar unsaturated monomers such as (meth)acrylic |
| | acid, hydroxyethyl (meth)acrylate or vinylpyridine |
| HNBR | partially hydrogenated or fully hydrogenated NBR rubbers |
| | with acrylonitrile contents of 5-60, preferably 10-50 wt. % |
| | and residual double bond content of 0-20, preferably 0-10% |
| EPM | ethylene/propylene copolymers |
| EPDM | ethylene/propylene/diene copolymers with diene contents |
| | between 0.1 and 20 wt. %, preferably 0.5 to 10 wt. % |
| FKM | fluorinated rubbers |
| CO | polyepichlorohydrin |
| ECO | copolymers of epichlorohydrin and ethylene oxide |
| EAM | ethylene/vinyl acetate copolymers with vinyl acetate contents |
| | of 20 to 90 wt. %, preferably 40 to 80 wt. % |
| | and also mixtures of these rubbers. |

For producing industrial rubber articles, rubbers with no or only a few double bonds with a C═C double bond concentration of 0 to 10 wt. % are preferred, in particular polyacrylate rubber and ethylene/C₁-C₄ alkyl acrylate copolymers, butyl rubber, bromobutyl rubber, chlorobutyl rubber, partially hydrogenated or fully hydrogenated NBR rubber, ethylene/propylene/diene copolymers and ethylene/vinyl acetate copolymers.

Most preferred are fully and partially hydrogenated NBR rubber (HNBR): butadiene/acrylonitrile copolymers with a concentration of copolymerized acrylonitrile of 5 to 60, preferably 10 to 50 wt. % are the parent compounds for the preferred (partially) hydrogenated nitrile rubbers. In this connection “hydrogenated” means that 90 to 100%, preferably 95 to 99.5% of the hydrogenatable C═C double bonds are hydrogenated. The degree of hydrogenation can be determined using IR spectroscopy. The hydrogenation of nitrile rubber is known (e.g. U.S. Pat. No. 3,700,637, DE-OS 25 39 132, 30 46 008, 30 46 251, 32 27 650, 33 29 974, EP-A 111 412, FR-PS 2 540 503). Suitable (partially) hydrogenated nitrile rubbers have Mooney viscosities ML 1+4 (100° C.) of 10 to 200, preferably 20 to 100. These types of HNBR rubbers are known and are commercially available (e.g. THERBAN® from Bayer AG).

Preferred rubbers have molecular weights between 100,000 and 2,000,000, preferably 150,000 to 1,500,000 (determined using gel permeation chromatography, GPC).

Apart from the polyurea fillers, rubber mixtures according to the present invention may also contain other fillers. Suitable other fillers for rubber mixtures according to the present invention are any known fillers which are used in the rubber industry, these including both active and inactive fillers.

The following may be mentioned:

highly dispersed silicas prepared, for example, by precipitation from solutions of silicates or by flame hydrolysis of silicon halides with specific surface areas of 5-1000, preferably 20-400 m²/g (BET) surface area) and with primary particle sizes of 10-400 nm. Optionally, the silica may also be present as a mixed oxide with other metal oxides such as Al, Mg, Ca, Ba, Zn, Zr, Ti oxides;

synthetic silicates such as aluminium silicate, alkaline earth silicates such as magnesium silicate or calcium silicate with BET surface areas of 20-400 m²/g and primary particle diameters of 10-400 nm;

natural silicates such as kaolin and other naturally occurring silicas;

glass fibers and glass fiber products (mats, ropes) or glass microbeads;

metal oxides such as zinc oxide, calcium oxide, magnesium oxide, aluminium oxide;

metal carbonates such as magnesium carbonate, calcium carbonate, zinc carbonate;

metal hydroxides such as e.g. aluminium hydroxide, magnesium hydroxide;

carbon black. The carbon blacks used herein are prepared by the lamp black, furnace black or channel black method and have BET surface areas of 20 to 200 m²/g, e.g. SAF, ISAF, HAF, FEF or GPF carbon black.

Highly dispersed silica and/or carbon black are preferred as additional fillers, wherein the mixing ratio of polyurea filler to carbon black and/or silica is 1:0.05 to 30, most preferably 1:0.1 to 10.

Rubber mixtures according to the present invention may also contain other rubber auxiliary substances which are used, for example, to cross-link the rubber mixtures, or which improve the physical properties of the vulcanizates prepared from rubber mixtures according to the invention for the specific ultimate purpose.

Sulfur or sulfur-providing compounds, methylol group-containing compounds, metal oxides or peroxides are used as cross-linking agents in amounts of 0.01 to 20 parts by wt., with respect to 100 parts by wt. of rubber. In addition, as mentioned above, rubber mixtures according to the present invention may also contain further auxiliary substances such as known reaction accelerators, co-crosslinking agents, in particular, polyacrylates, polyallyl ether and polymaleic imides such as e.g. trimethylolpropane triacrylate, triallyl isocyanurate or m-phenylene bis-maleic imide, antioxidants, thermal stabilizers, light protection agents, ozone protection agents, processing auxiliary substances, reinforcing resins, e.g. phenol resins, steel wire bonding agents such as silica/resorcinol/hexamethylene-tetramine or cobalt naphthenate, plasticizers, tackifiers, blowing agents, colorants, pigments, waxes, extenders, organic acids, retarders, metal oxides and filler activators e.g. polysulfidic silanes such as bis-(triethoxysilylpropyl) tetrasulfide.

Rubber auxiliary agents according to the present invention are used in conventional, known amounts, wherein the amount used is governed by the subsequent ultimate use of the rubber mixtures. Conventional amounts of rubber auxiliary substances are, for example, in the range 2 to 70 parts by wt., with respect to 100 parts by wt. of rubber.

Rubber mixtures according to the present invention may also be prepared by mixing the rubber with the separately prepared polyurea fillers and optionally other fillers, rubber auxiliary agents and cross-linking agents in suitable mixing equipment such as compounders, rollers or extruders. The rubber/polyurea mixture is preferably prepared from the rubber solution by the preparation process according to the present invention.

The present invention also provides use of rubber mixtures according to the present invention to produce vulcanizates and highly reinforced rubber molded items, preferably for the preparation of industrial rubber articles made from EPDM rubber, butyl rubber, halobutyl rubber and hydrogenated acrylonitrile/butadiene rubber, and for low rolling resistance tire treads, in particular those based on BR, IR, NR or SBR rubbers, low-damping tire side-walls for tires with emergency running properties, as described in U.S. Pat. Nos. 5,368,082, 5,427,166, 5,511,599 and EP-A 475 258, and also gas-tight and low-damping tire inner tubes, in particular those based on butyl, bromobutyl or chlorobutyl rubbers.

The rubber mixtures are preferably used to produce tires and industrial rubber articles.

The present invention also provides rubber vulcanizates, rubber molded items of all types, in particular tires and industrial rubber articles, which are produced in a conventional manner using rubber mixtures according to the present invention.

### EXAMPLES

### Example 1

### Mixture of Hydrogenated NBR rubber and 25 phr of a Polyurea Based on Polymethylene-polyphenyl Isocyanate and Ethylene Diamine

To a solution of 500 g of HNBR rubber Therban A 3406 (HNBR with a 34% acrylonitrile content, residual double bond content <0.9%, Bayer AG) in 4 l of chlorobenzene were added 102.1 g of Desmodur 44VV20 L (mixture of diphenylmethane diisocyanate with isomers and higher-functional homologues, NCO content 31.5%, viscosity 200 mPa.s, Manufacturer: Bayer AG). Then a solution of 23.0 g of ethylene diamine in 100 ml of chlorobenzene was added to this mixture dropwise, at room temperature, with stirring (200 rpm), over the course of 25 minutes and then the mixture was stirred for 1 hour at 100° C. A finely divided, white dispersion with a particle size between 0.5 and 10 μm (determined using a visible light microscope) was produced. Then the solvent was distilled off with steam. After drying at 125° C. under vacuum, 624 g of HNBR rubber mixture with 25 phr polyurea filler and a viscosity ML 1+4 (100° C.) of 109 were obtained. The polyurea filler had a melting or decomposition temperature >230° C. (from DSC). The glass transition temperature of the rubber mixture was −25° C., the polyurea filler did not have a glass transition temperature.

### Example 2

### Mixture of Hydrogenated NBR Rubber and 25 phr of a Polyurea Based on Toluylene Diisocyanate and Ethylene Diamine

The same procedure as described in example 1 was used, wherein 500 g of the same rubber were used, 93.1 g of toluylene diisocyanate Desmodur T 80 (Bayer AG) were used as the polyisocyanate component and 32.1 g of ethylene diamine were used as the polyamine component. 625 g of HNBR rubber mixture with 25 phr polyurea filler and a viscosity ML 1+4 (100° C.) of 114 were obtained. The polyurea filler had a melting or decomposition temperature >250° C. (from DSC). The glass transition temperature of the rubber mixture was −25° C., the polyurea filler did not have a glass transition temperature.

### Example 3

### Mixture of Hydrogenated NBR Rubber and 25 phr of a Polyurea Based on Polymethylene-polyphenyl Isocyanate, Ethylene Diamine and Amine Group-containing NBR Oil

To a solution of 500 g of HNBR rubber Therban A 3406 (HNBR with 34% acrylonitrile content, residual double bond content <0.9%, Bayer AG) in 4 l of chlorobenzene were added 92.0 g of Desmodur 44V20 L (mixture of diphenylmethane diisocyanate with isomers and higher-functional homologues, NCO content 31.5%, viscosity 200 mPa.s, Manufacturer: Bayer AG). Then a solution of 20.7 g of ethylene diamine and 12.5 g of amino-terminated liquid acrylonitrile/butadiene copolymer (18 wt. % acrylonitrile, amine equivalent 900) in 100 ml of chlorobenzene were added dropwise to this mixture, at room temperature, with stirring (200 rpm), within 25 minutes and then the mixture was stirred for one hour at 100° C. A finely divided white dispersion with a particle size between 0.5 and 5 μm (determined by visible light microscopy) was produced. The solvent was then distilled off with steam. After drying at 125° C. under vacuum, 687 g of HNBR rubber mixture with 37.5 phr of polyurea filler and a viscosity ML 1+4 (100° C.) of 120 were obtained. The polyurea filler had a melting or decomposition temperature >230° C. (from DSC). The glass transition temperature of the rubber mixture was −26° C.

### Example 4

### Mixture of Bromobutyl Rubber and 50 phr of a Polyurea Filler Based on TDI

To a solution of 500 g of bromobutyl rubber Polysar Brombutyl X2 (1.8 wt. % bromine content, average molecular weight (weight average) by GPC: 350,000, Bayer AG) in 4 l of cyclohexane were added 186.2 g of Desmodur T 80 (toluylene-2,4/2,6 diisocyanate mixture (80:20) from Bayer AG). Then, 64.2 g of ethylene diamine were added, with stirring (200 rpm), at room temperature, within 15 minutes, and then the mixture was stirred for one hour at 80° C. A homogeneous dispersion of polyurea particles with a particle diameter between 0.1 and 10 μm, of which 50% of the particles were ≦0.8 μm (measured with an ultracentrifuge), was produced. Then 2.5 g of the antioxidant Vulkanox 4020 (Bayer AG) were stirred in. After drying at 70° C. under vacuum, 746 g of homogeneous polyurea-filled bromobutyl rubber mixture with a viscosity ML 1+4 (100° C.) of 131 were obtained. The polyurea filler had a melting or decomposition temperature >240° C. (by TGA, heating at 20 K/min). The glass transition temperature of the rubber mixture was −64° C., the polyurea filler did not have a glass transition temperature.

### Example 5

### (Comparison Example): Polyurea Based on Polymethylene-polyphenyl Isocyanate and Ethylene Diamine with Particle Sizes of 500-2000 μm.

To a solution of 459.6 g of Desmodur 44V20 L (mixture of diphenylmethane diisocyanate with isomers and higher-functional homologues, NCO content 31.5%, viscosity 200 mPa.s, Manufacturer: Bayer AG) in 4 l of chlorobenzene were added 103.5 g of ethylene diamine, dropwise, at room temperature, with stirring (200 rpm), within 20 minutes and then the mixture was heated under reflux for 1 hour. Then the precipitated solids were filtered off, dried under vacuum and screened through a sieve with a 2000 μm mesh size. Finally, fines of less than 500 μm were removed via a sieve with a 500 μm mesh size. The polyurea filler had a melting or decomposition temperature >230° C. (from DSC) and a particle size between 500 and 2000 μm.

### Example 6

### Rubber Vulcanizates

The following rubber mixtures were prepared in a 1.5 l compounder. Speed 50 rpm, mixing time 5 minutes, initial temperature 50° C. Finally, the peroxide (bis-(tert.butyl-peroxyisopropyl)benzene) was admixed on a roller (roller temperature: 20° C.).

TABLE 1

| | | | Ex- |
|---|---|---|---|
| | Compari- | Compari- | am- |
| | son | son | ple |
| | 6-A | 6-B | 6.1 |
| Mixed in the compounder: | | | |
| HNBR rubber Therban 3406 (Bayer AG) | 100 | 100 | 0 |
| HNBR/polyurea mixture according to | 0 | 0 | 125 |
| example 1 | | | |
| Carbon black Corax N 550 (Degussa-Hüls | 25 | 0 | 0 |
| AG) | | | |
| Polyurea with particle sizes between 500 | 0 | 25 | 0 |
| and 2000 μm according to Example 5 | | | |
| Zinc oxide: | 2 | 2 | 2 |
| Admixed on the roller: | | | |
| bis-(tert.butyl-peroxyisopropyl)benzene | 5 | 5 | 5 |
| Perkadox 14/40 B (Akzo) | | | |

The rubber mixtures were then vulcanized at 180° C. for 15 minutes. The following vulcanizate properties were found:

TABLE 2

| | | | Exam- |
|---|---|---|---|
| | Comparison | Comparison | ple |
| | 6-A | 6-B | 6.1 |
| Vulcanizate properties: | | | |
| Modulus at 300% extension (MPa) | 9.9 | 5.5 | 11.6 |
| Tensile strength (MPa) | 32.5 | 7.1 | 25.6 |
| Extension at break (%) | 534 | 396 | 417 |
| Hardness at 23° C. (Shore A) | 59 | 63 | 65 |
| Rebound resilience at 70° C. (%) | 60 | 59 | 60 |
| Abrasion DIN 53 516 (ccm) | 62 | 104 | 50 |
| Density (g/ccm) | 1.073 | 1.028 | 1.032 |

### Example 7

### Rubber Vulcanizates

The following rubber mixtures were prepared in a 1.5 l compounder. Speed 50 rpm, mixing time 5 minutes, initial temperature 50° C. Finally, zinc oxide was admixed on a roller (roller temperature: 20° C.).

TABLE 3

| | Comparison | Example |
|---|---|---|
| | 7-A | 7.1 |
| Mixed in the compounder: | | |
| Bromobutyl rubber | 100 | 0 |
| Polysar bromobutyl X2 (Bayer AG) | | |
| Bromobutyl/polyurea mixture according to | 0 | 150 |
| example 4 | | |
| Carbon black Corax N 550 (Degussa-Hüls AG) | 50 | 0 |
| Stearic acid | 1 | 1 |
| Admixed on the roller: | | |
| zinc oxide | 5 | 5 |

The rubber mixtures were then vulcanized at 180° C. for 10 minutes. The following vulcanizate properties were found:

TABLE 4

| | Comparison | Example |
|---|---|---|
| | 7-A | 7.1 |
| Vulcanizate properties: | | |
| Modulus at 100% extension (MPa) | 1.1 | 2.8 |
| Extension at break (%) | 511 | 255 |
| Hardness at 23° C. (Shore A) | 49 | 61 |
| Rebound resilience at 23° C. (%) | 12 | 14 |
| Rebound resilience at 70° C. (%) | 41 | 56 |
| Density (g/ccm) | 1.139 | 1.061 |

### Example 8

### Rubber Vulcanizates

The following rubber mixtures were prepared in a 1.5 l compounder. Speed 50 rpm, mixing time 5 minutes, initial temperature 50° C. Finally, the peroxide was admixed on a roller (roller temperature: 20° C.). The amounts given refer to parts by weight:

TABLE 5

| | Comparison | Example |
|---|---|---|
| | 8-A | 8.1 |
| Mixed in the compounder: | | |
| HNBR rubber Therban 3406 (Bayer AG) | 100 | 44 |
| HNBR/polyurea mixture according to | 0 | 75 |
| example 2 | | |
| Carbon black Thermax N 990 (R. T. | 55 | 55 |
| Vanderbilt) | | |
| MgO Maglite (Nordmann & Rassmann) | 5 | 5 |
| Vulkanox ZMB2 (Bayer AG) | 0.4 | 0.4 |
| Zinc oxide | 2.5 | 2.5 |
| Rhenofit DDA-70 (Rheinchemie) | 1.1 | 1.1 |
| Stearic acid | 1 | 1 |
| Plasticizer Plasthall P-670 (C. P. Hall) | 5 | 5 |
| Plasticizer Halico C-491 (C. P. Hall) | 6 | 6 |
| Admixed on the roller: | | |
| peroxide polydispersion T D-40P VC | 10.5 | 10.5 |
| (Rheinchemie) | | |
| m-phenylene-bis-maleic imide (DuPont) | 2 | 2 |

The rubber mixtures were then vulcanized at 180° C. for 15 minutes. The following vulcanizate properties were found:

TABLE 6

| | Comparison | Example |
|---|---|---|
| | 8.A | 8.1 |
| Vulcanizate properties: | | |
| Modulus at 100% extension (MPa) | 2.4 | 3.7 |
| Modulus at 300% extension (MPa) | 7.6 | 12.1 |
| Tensile strength (MPa) | 13.3 | 18.2 |
| Extension at break (%) | 278 | 259 |
| Hardness at 23° C. (Shore A) | 59 | 68 |
| Abrasion DIN 53 516 (ccm) | 71 | 64 |

The vulcanizates were then stored for 14 days at 150° C. The following changes in mechanical properties were detected.

TABLE 7

| | Comparison | Example |
|---|---|---|
| | 8-A | 8.1 |
| Vulcanizate properties after | | |
| storing 14 d/150° C.: | | |
| Modulus at 100% extension (MPa) | 4.7 | 7.0 |
| Tensile strength (MPa) | 16.1 | 19.0 |
| Extension at break (%) | 260 | 240 |
| Hardness at 23° C. (Shore A) | 72 | 79 |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Rubber mixtures comprising a rubber and 1 to 300 parts by wt., with respect to 100 parts by wt. of rubber, of a polyurea filler with a particle size of 0.001 to 500 μm and optionally, further rubber auxiliary substances and cross-linking agents.

2. Rubber mixtures according to claim 1, wherein the rubber mixtures contain 5 to 150 parts by wt. of polyurea filler, with respect to 100 parts by wt. of rubber.

3. Rubber mixtures according to claim 1, wherein said particle size is from 0.001 to 100 μm.

4. Rubber mixtures according to claim 1, wherein said particle size is from 0.001 to 20 μm.

5. A process for preparing polyurea-filled rubber mixtures comprising a rubber and 1 to 300 parts by wt., with respect to 100 parts by wt. of rubber, of a polyurea filler with a particle size of 0.001 to 500 μm and optionally, further rubber auxiliary substances and cross-linking agents, comprising the steps of reacting a polyisocyanate with a polyamine and/or water at temperatures of −50 to 250° C. in a solvent with precipitation of the polyurea, and adding a solution of a rubber to the polyurea obtained and removing the solvent.

6. A process according to claim 5, wherein the polyisocyanate is reacted with the polyamine in a solution of the rubber or in an emulsion of the rubber solution and water.

7. A process according to claim 5, wherein the relative amounts of polyisocyanate used to polyamine used is 0.7 to 1.3 mol of isocyanate groups per mol of amine groups and the water is optionally used in large excess.

8. A molded item comprising rubber mixtures comprising a rubber and 1 to 300 parts by wt., with respect to 100 parts by wt. of rubber, of a polyurea filler with a particle size of 0.001 to 500 μm and optionally, further rubber auxiliary substances and cross-linking agents.

9. A molded item according to claim 8, wherein said molded item is an industrial rubber article or tire.

10. A vulcanizate comprising a rubber and 1 to 300 parts by wt., with respect to 100 parts by wt. of rubber, of a polyurea filler with a particle size of 0.001 to 500 μm and optionally, further rubber auxiliary substances and cross-linking agents.

11. A vulcanizate according to claim 10, wherein said vulcanizate is an industrial rubber article or tire.
